(19) United States
(12) Patent Application Publication
(10) Pub. No.: US 2026/0289532 A1
(43) Pub. Date: Sep. 24, 2026

(54) CROSS-BORDER FUNDS TRANSFER TO DOMESTIC ACCOUNT VIA GLOBAL DIGITAL WALLET

(71) Applicant: VISA INTERNATIONAL SERVICE ASSOCIATION, San Francisco, CA (US)

(72) Inventors: Ramji Sethuraman, Foster City, CA (US); Jarkko Oskari Sevanto, Berkeley, CA (US); Sushma Rapolu, San Rafael, CA (US); Vikram Modi, Lafayette, CA (US); Shreya Viswanathan, Foster City, CA (US)

(73) Assignee: VISA INTERNATIONAL SERVICE ASSOCIATION, San Francisco, CA (US)

(21) Appl. No.: 19/082,578

(22) Filed: Mar. 18, 2025

(51) Int. Cl. G06Q 20/10; G06Q 20/36; G06Q 20/40

(52) U.S. Cl. CPC G06Q 20/10; G06Q 20/36; G06Q 20/40

(57) ABSTRACT

Cross-border funds transfer is enabled from a sender account outside of a first country to a recipient account in the first country via a global digital wallet that has instances in the first country and outside of the first country. A dual token setup is provided for an alias in a first country thereby allowing a sender outside of the first country to send funds to the recipient in the first country. The first country blocks real-time transfer of inbound funds from accounts outside of the first country. Embodiments ensure regulatory compliance while promoting efficient cross-border funds transfer. Original Credit Transaction (OCT) is used to move funds between entities within the foreign country or countries, and a cross-border internal ledger transfer between a global digital wallet's foreign instance and domestic instance.

### CROSS-REFERENCES TO RELATED APPLICATIONS

None.

### BACKGROUND

Transaction systems such as cross-border payment systems have many challenges. Currently, there is no real-time incoming cross-border money movement into a user account (e.g., bank account or a digital wallet account) issued by an issuer in United States from a foreign account in a foreign country. Existing regulations prohibit US inbound cross-border Original Credit Transaction (OCT)s, restricting money movement. Digital wallet platforms (e.g., PayPal, Apple cash, Cash app) are confined to closed-loop cross-border money movement, requiring both the sender account and the recipient account be issued by the digital wallet platform, limiting their reach.

Embodiments of the disclosure address this problem and other problems individually and collectively.

### SUMMARY

Embodiments introduce a dual token solution for domestic account aliases identifying an account in a first country (e.g., United States) and simplifies the process for foreign entities to send funds from foreign accounts to the accounts in the first country via a global digital wallet platform, by implementing an internal ledger transfer between a foreign instance of the global digital wallet platform (e.g., PayPal Canada) and a domestic instance of the global digital wallet platform (e.g., PayPal US). Embodiments eliminate the confines of closed-loop systems, allowing senders without accounts on the global digital wallet platform to send funds to domestic recipient accounts in the first country, thereby broadening the reach of global digital wallet platforms. Techniques described herein comply with existing cross-border funds transfer regulations.

According to various embodiments, a network processing server facilitates generation of a second token for the recipient alias that can be used in a cross-border funds transfer. The network processing server partners with an authorizing entity in a second country outside the first country to generate virtual accounts associated with the recipient alias. The second token is linked to the virtual account to which the OCT will be delivered in the second country. Funds are then transferred cross-border via internal ledger transfer of the global digital wallet platform.

Various embodiments provide a method. The method comprises receiving, by a network processing server, from a sender outside of a first country, a request to resolve a recipient alias of a recipient to a token. The method further comprises determining, by the network processing server, that the sender is outside of the first country and the recipient alias is associated with a destination recipient account in the first country that blocks real-time transfer of inbound funds from accounts outside of the first country. The method includes retrieving, by the network processing server, a foreign token associated with the recipient alias based on identifying that the sender is outside of the first country. The foreign token is associated with a virtual recipient account issued by a recipient authorizing entity in a second country. The method further comprises transmitting, by the network processing server, the foreign token to the sender; and receiving, by the network processing server, from a sender authorizing entity outside of the first country, a funds transfer request including the foreign token and a transfer amount. The method also comprises transmitting, by the network processing server, a real-time funds transfer request to a foreign instance of a global digital wallet in the second country via the recipient authorizing entity in the second country. The global digital wallet transfers the transfer amount in real-time to the destination recipient account in the first country via a ledger transfer internal to the global digital wallet.

Some embodiments provide a network processing server comprising a processor and a computer-readable medium comprising code, executable by the processor to perform the method described above.

A better understanding of the nature and advantages of embodiments may be gained with reference to the following detailed description and accompanying drawings.

### BRIEF DESCRIPTION OF THE DRAWINGS

FIG. 1 illustrates a block diagram of entities in a cross-border funds transfer according to current techniques.

FIG. 2 illustrates a block diagram of entities in a cross-border funds transfer according to various embodiments.

FIG. 3 shows a flow diagram illustrating a method for cross border funds transfer, according to embodiments.

FIG. 4 shows exemplary account identifying information, according to various embodiments.

FIG. 5 illustrates a block diagram of a network processing server, according to various embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “recipient” can be an entity that receives something. The recipient can be a user associated with a recipient record (e.g., an account). A recipient can operate a recipient user device.

A “sender” can be an entity that sends something. The sender can be a user associated with a sender record (e.g., an account). A sender can operate a sender user device.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “financial application” can include an application facilitating the transfer of funds between multiple parties. The financial application (“financial app”) can be executed on a mobile device associated with a user, and the financial application can be implemented using a server (e.g., an application server) in communication with the mobile device. The financial application of a sender can allow a user to select a recipient user to transfer a specified amount of funds to the recipient user. The financial application can then coordinate the transfer the specified amount from an account for the sender to an account for the recipient user.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “digital wallet” can include an application executing on an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/ personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card. A digital wallet may be a transfer application.

“Account information” may include any suitable information associated with an account (e.g., a personal account number and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

An “alias” may be nickname associated with a real identifier. An alias can be a phone number, e-mail address, username, etc. associated with a user's real name (e.g., John Smith). An alias can have any suitable number of type of characters. An alias can be used to conduct transfers instead of sensitive information. This preserves privacy and data security.

A “server computer” is typically a powerful computer or cluster of computers.

For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “network processing server” may include a server computer used for interaction processing. In some embodiments, the network processing computer may be coupled to a database and may include any hardware, software, other logic, or combination of the preceding for servicing the requests from one or more client computers. The network processing computer may comprise one or more computational apparatuses and may use any of a variety of computing structures, arrangements, and compilations for servicing the requests from one or more client computers. In some embodiments, a network processing computer may include data processing subsystems, networks, and operations used to support and deliver authorization services, exception file services, and clearing and settlement services. An exemplary network processing computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The network processing computer may use any suitable wired or wireless network, including the Internet.

The network processing computer may process interaction-related messages (e.g., funds transfer related messages) and determine the appropriate destination computer (e.g., an authorizing entity computer) for the interaction-related messages. The network processing computer may also handle and/or facilitate the clearing and settlement of interactions.

An “authorizing entity” may be an entity that authorizes a request. Examples of an authorizing entity may be an issuer, a governmental agency, a document repository, an access administrator, etc. An authorizing entity may operate an authorizing entity computer.

An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

Embodiments provide efficient methods for cross-border funds transfer from a sender account outside of a first country to a recipient account in the first country (e.g., to a recipient account in United States) via a global digital wallet (e.g., PayPal, CashApp) that has instances in the first country and outside of the first country. In some embodiments the sender may be in a second country, and the foreign instance of the global digital wallet may be in a third country. In other embodiments, the sender and the foreign instance of the global digital wallet may both be in a same country (e.g., second country) outside of the first country.

According to various embodiments, a network processing server may provide a dual token setup (e.g., a first domestic token and a second foreign token) for an alias in a first country (e.g., United States) thereby allowing a sender outside of the first country to send funds to the recipient in the first country. According to various embodiments, the first country blocks real-time transfer of inbound funds from accounts outside of the first country. For example, United States does not allow a sender outside of the United States to transfer funds to an account issued in the United States. The first domestic token may be used for transactions performed using the alias in the first country. The second foreign token may be used for transactions performed using the alias outside of the first country.

Embodiments break away from the confines of closed-loop systems, and broaden the reach of global digital wallet platforms. Embodiments ensure regulatory compliance while promoting efficient cross-border funds transfer (e.g., money movement). Various embodiments provide US inbound cross-border funds transfers, enabling foreign entities (e.g., a sender in Canada) to seamlessly send money to recipient accounts in the United States. According to various embodiments, Original Credit Transaction (OCT) is used to move funds between entities within the foreign country or countries (e.g., Canada), and a cross-border internal ledger transfer between a global digital wallet's foreign instance and US instance (e.g., PayPal Canada and PayPal US).

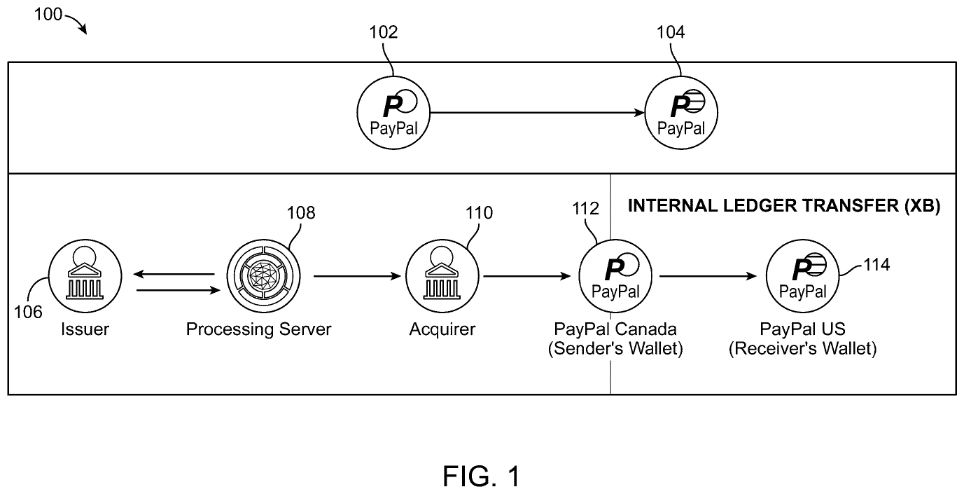

FIG. 1 illustrates a cross-border funds transfer 100 from an instance of a global digital wallet platform 102 in a second country into an instance of the global digital wallet platform 104 in a first country according to current techniques.

A sender in a second country outside of a first country (e.g., the first country may be United States, and the sender may be in Canada) may transfer funds to a recipient in the first country by instructing their issuer bank 106 to transfer funds, via a network processing server 108, to an acquirer 110 in the second country. The instructions may further include the transfer amount and the recipient's account information with the global digital wallet platform. The transfer from the issuer bank 106 to the acquirer 110 in the second country occurs via an Account Funding Transaction (AFT), as a pull transaction that pulls the funds from the sender account at the issuer 106 and transfers the funds to the acquirer 110.

Current cross-border funds transfer techniques for transferring funds from an account outside United States to an account in United States use global digital wallet accounts. This technique requires both the sender and the recipient to be registered with (e.g., have accounts with) the global digital wallet platform. Therefore in FIG. 1, the acquirer 110 relays the funds to a sender's digital wallet account 112 with the instance of the global digital wallet in the second country 102. As provided above, current techniques require the sender to be registered with the global digital wallet platform. The AFT is used to transfer the funds into the global digital wallet's instance in the second country (e.g., PayPal Canada). The global digital wallet platform may move the funds cross-border from the sender's digital wallet account 112 to a recipient's digital wallet account 114 on the global digital wallet's instance in the first country (e.g., PayPal US) through an internal ledger transfer.

If the sender does not wish to register with the global digital wallet platform, the sender is prevented from sending funds in real-time to the recipient's account in the first county. Embodiments eliminate the requirement for the sender to register with any service provider to effectuate a funds transfer to the recipient's account in the first country. Accordingly, embodiments provide an alternative path to the sender without forcing the sender to register with a service provider.

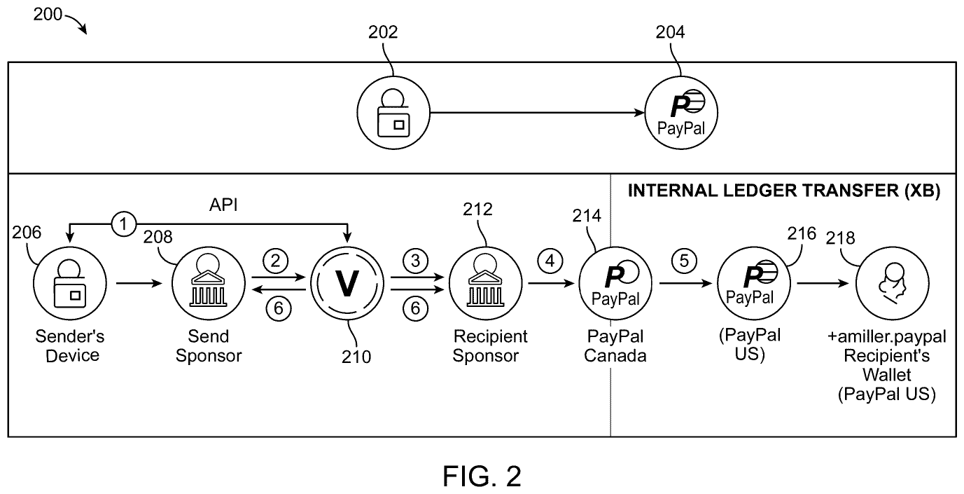

FIG. 2 illustrates a cross-border funds transfer 200 from a sender account 202 outside of a first country into a recipient account 204 in the first country according to various embodiments. As mentioned above, it is assumed that the first country blocks real-time transfer of inbound funds from accounts outside of the first country. For example, United States does not allow a sender outside of the United States to transfer funds to an account issued in the United States in real-time.

According to the technique shown in FIG. 2, the sender outside of the first country may not be registered (e.g., may not have an account with) the global digital wallet (e.g., PayPal, CashApp, Apple Cash). According to various embodiments, the funds transfer is handled via a domestic Original Credit Transaction (OCT) transfer within a second country, which is then followed by an internal ledger transfer between an instance of the global digital wallet platform in the second country 214 (e.g., PayPal Canada) to move the funds cross-border to a recipient wallet 218 on an instance of the global digital wallet platform in the first country (e.g., PayPal US) 216. Accordingly, embodiments allow a non-registered user with the global digital wallet to effectuate a cross-border real-time funds transfer into a recipient's account in the first country via the global digital wallet platform.

While FIG. 2 illustrates the sender being located in the same country as a recipient authorizing entity 212 (e.g., recipient sponsor), according to various embodiments, the sender may be located in a third country (e.g., Peru), the recipient authorizing entity 212 and the global digital wallet's foreign instance 214 may be located in a second country (e.g., Canada), and the recipient is located in the first country (e.g., United States). For example, cross-border funds transfer arrives from a foreign sender account to a domestic US recipient account. The global digital wallet's foreign instance may act as a transfer hub (e.g., global digital wallet hub) for the cross-border transfers coming from any foreign country into a domestic US account. In such embodiments, the funds are transferred via cross-border OCT from the sender account to the global digital wallet's foreign instance. The global digital wallet's foreign instance is located in a country that does not block cross-border transfers.

As mentioned above, the cross-border funds transfer has two segments: in the first segment, the funds are transferred via OCT to the global digital wallet's foreign instance 214. The funds may be transferred via domestic OCT if the sender and the recipient authorizing entity 212 and/or the global digital wallet's foreign instance 214 are located in the same country. The funds may be transferred via cross-border OCT if the sender and the recipient authorizing entity 212 and/or the global digital wallet's foreign instance 214 are located in different countries.

In the second segment, the funds are moved cross-border within the global digital wallet platform via an internal ledger transfer between the global digital wallet instance in the foreign country 214 and the global digital wallet instance in the first country 216. Embodiments provide improvements in getting the funds to the global digital wallet platform, from where the funds can be transferred to the global digital wallet instance in the first country, which is linked to a user account (e.g., bank account) in the first country.

At FIG. 2, the sender may initiate the funds transfer by entering a recipient alias (e.g. an alias or a payname issued by the network processing server 210) and a transfer amount to a financial app (or a financial portal, website) executing on the sender's user device 206. The recipient alias may be associated with a first (domestic) token identifying a domestic account in the first country (e.g., issued by an authorizing entity such as a bank in the first country) and a second (foreign) token that is a valid credential outside of the first country (e.g., in the second country where the global digital wallet hub is located). The second foreign token may be associated with a foreign account issued by the recipient authorizing entity 212 (e.g., recipient sponsor) in the second country. According to various embodiments, the recipient authorizing entity 212 is affiliated with (e.g., works together with) the network processing server 210. The network processing server 210 may instruct the recipient authorizing entity 212 to generate a virtual account (e.g., second account represented by a primary account number including a foreign BIN) associated with the recipient alias, and the network processing server 210 may generate the second foreign token for the virtual account (e.g., the second foreign token represents the virtual account).

According to an exemplary embodiment illustrated in FIG. 2, the recipient alias “+amiller.paypal” may be associated with a first token for domestic use in the first country identifying a first primary account number (PAN #1 including a domestic BIN, and configured to receive and dispense funds in the local currency of the first country) and a second token for use outside of the first country (e.g., in the second country) identifying a second primary account number (PAN #2, which may be a virtual PAN, including a foreign BIN, and configured to receive and dispense funds in the currency of the first country. As mentioned above, the first country may be United States, that does not allow real-time transfer of funds into a US account, and the second country may be any foreign country, such as Canada. The second PAN (generated by the recipient authorizing entity 212) and the second token (generated by the network processing server 210) are generated to be associated with the recipient alias, which is also associated with the first token. Upon generating the second token, the network processing server 210 may store the first token and the second token in a token vault associated with the recipient alias.

At step 1 of FIG. 2, after the sender initiates the funds transfer on the financial app executing on the sender's user device 206, the alias may be resolved into the second token (e.g., the foreign token) associated with the alias. For example, the financial app may use an API (e.g., “resolve alias API”) with the network processing server 210 to provide the recipient alias, and obtain the second token from the network processing server 210. According to various embodiments, the network processing server 210 may identify whether the resolve alias API call is received from an entity in the first country or outside of the first country. If the network processing server 210 determines that the API call is received from an entity in the first country, the network processing server 210 may return the first token to the requestor. If the network processing server 210 determines that the API call is received from an entity outside of the first country, the network processing server 210 may return the second token.

At step 2, the sender (via the financial app) sends a funds transfer request including the second token and a transfer amount to a sender authorizing entity 208 (e.g., send sponsor) in the second country. In some embodiments, the financial app may be managed by the sender authorizing entity 208. In some embodiments, the sender authorizing entity 208 may be a financial institution, such as a bank, in the second country. The sender is not required to be registered with or have an account with the global digital wallet, and/or the sender may not have an alias for themselves. The sender may use the sender authorizing entity where they already have an account, and therefore with whom they are familiar and comfortable transacting. The funds transfer request is a token-based OCT in the destination currency (e.g., USD). If necessary, the financial app can handle the currency conversion from the local currency to destination currency. In some embodiments, the transfer amount entered by the sender may already be in the destination currency.

After receiving the token-based OCT request (including the second token and the transfer amount), the network processing server 210 detokenizes the second token to obtain the second primary account number (PAN #2 including the foreign identifier in the second country, and configured to receive and dispense funds in USD) issued by the recipient authorizing entity 212 (e.g., receive sponsor). In some embodiments, the foreign identifier (e.g., BIN) may be associated with the global digital wallet (e.g., global digital wallet's instance in the second country 214). That is, the foreign identifier may indicate an account that is created for (or on behalf of) the global digital wallet's instance in the second country 214.

At step 3, the network processing server 210 generates and transmits a PAN-based OCT request including the second PAN and the transfer amount to the recipient authorizing entity 212 (e.g., receive sponsor). The PAN-based OCT request message structure may allow for cross-border screening information (e.g., sender name, recipient name, account numbers) to be transmitted. The funds transfer request may include a field indicating that the ultimate recipient of the funds is in the first country so that the authorizing entities (e.g., the sender authorizing entity 208 and/or the recipient authorizing entity 212) may perform any validation or screening that they need to perform for cross-border transactions. The funds transfer request may include all information (e.g., sender name, recipient name) required for the validation and screening.

At step 4, the recipient authorizing entity 212 provides information (e.g., the second PAN, the transfer amount) to enable the global digital wallet's instance in the second country 214 (e.g., PayPal, CashApp) to make the funds available in the recipient wallet 218 maintained by the global digital wallet's instance in the first country 216.

At step 5, the global digital wallet moves the funds from their instance in the second country 214 (e.g., Canada in the exemplary embodiment shown in FIG. 2) to the global digital wallet's instance in the first country 216 (e.g., United States in the exemplary embodiment shown in FIG. 2) using an internal ledger transfer (internal to the global digital wallet). The internal ledger transfer finalizes the real-time transfer of funds from the sender's account outside of the first country to the recipient account in the first country.

At step 6, the network processing server 210 settles with the sender authorizing entity 208 (e.g., the send sponsor) in the foreign currency and the recipient authorizing entity 212 (e.g., the receive sponsor) in the currency of the first country following a settlement process.

As provided above, the cross-border funds transfer may be in real-time. For example, steps 2 and 3 may be the real-time OCT going from the sender authorizing entity 208 through the network processing server 210 to the recipient authorizing entity 212. According to a first option, the recipient authorizing entity 212 can process the real-time message and notify the global digital wallet's instance in the second country 214. According to a second option, step 3 and 4 may be combined such that the network processing server 210 may send the PAN-based OCT request including the second PAN and the transfer amount directly to the global digital wallet's instance in the second country 214 in form of a real-time authorization request. The PAN-based OCT request message structure may allow for cross-border screening information (e.g., sender name, recipient name, account numbers) to be transmitted. The settlement may still occur between the network processing server 210 and the recipient authorizing entity 212.

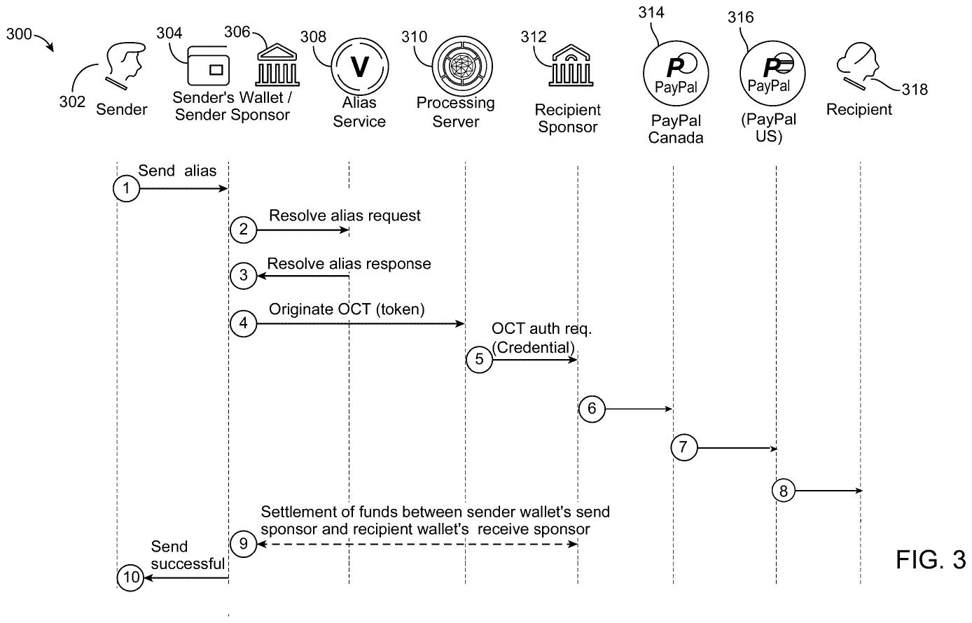

FIG. 3 shows a flow diagram 300 illustrating a method for cross border funds transfer, according to embodiments.

According to the exemplary embodiment illustrated in FIG. 3, the sender 302 may wish to send funds to a recipient 318 located in a different country. The recipient 318 may be located in a first country, and the sender 302 may be located outside of the first country, for example in a second country. The first country may block all incoming real-time fund transfers from outside of the first country. The recipient may have a domestic user account in the first country that is associated with a recipient alias. According to various embodiments, the recipient alias may be generated by an alias service 308 and provided to the recipient 318. The alias service may store a mapping between the recipient alias and the domestic user account of the recipient 318. The recipient may provide the recipient alias to the sender 302.

At step 1, the sender 302 may provide the recipient alias and a transfer amount to a sender authorizing entity 306. The sender 302 may have an account issued by the sender authorizing entity 306 in the second country. The funds will be debited to the account of the sender with the sender authorizing entity 306. The sender 302 may also have an app 304 executing on a sender user device (e.g., a digital wallet app, a financial app) that can communicate with the sender authorizing entity 306. The sender 302 may provide the recipient alias to the app 304, which may provide it to the sender authorizing entity 306.

At step 2, the sender authorizing entity 306 may transmit an alias resolve request message including the recipient alias to the alias service 308 requesting the alias service 308 to provide a token associated with the recipient alias. According to various embodiments, the alias service 308, when generating the recipient alias for the recipient, may also work with the network processing server 310 to generate a first token (e.g., domestic token) for use in the first country and a second token (e.g., foreign token) for use outside of the first country. The alias service 308 may determine whether the alias resolve request is received from an entity in the first country or outside of the first country. If the alias service 308 determines that the alias resolve request is received from the sender authorizing entity 306 that is outside of the first country, the alias service 308 returns the second token for use outside of the first country at step 3. The alias service 308 may provide additional token information (e.g., recipient name, token expiration date) along with the second token.

According to various embodiments, the alias service 308 may be managed by, or otherwise embedded in, the network processing server 310. Accordingly, the network processing server 310 may receive the request to resolve the recipient alias to a token. The network processing server 310 may then determine that the sender 302 is outside of the first country and the recipient alias is associated with a destination recipient account in the first country that blocks real-time transfer of inbound funds from accounts outside of the first country. The network processing server 310 retrieves the second token (e.g. a foreign token) associated with the recipient alias based on identifying that the sender 302 is outside of the first country, and transmits the second token to the sender authorizing entity 306. The second token is associated with a virtual recipient account issued by a recipient authorizing entity 312 in the second country.

At step 4, the sender authorizing entity 306 generates a first funds transfer request message including the second token and the transfer amount (e.g., a token-based OCT message) and transmits the first funds transfer request message to the network processing server 310. Upon receiving the first funds transfer request message, the network processing server 310 identifies the second token in the first funds transfer request message, and retrieves an account number associated with the second token. According to various embodiments, the network processing server 310 may store a mapping between tokens and corresponding account identifiers at a token vault (e.g., a secure database). The network processing server 310 may identify a recipient account identifier associated with a virtual recipient account in the second country. According to various embodiments, the network processing server 310 may have previously provided identity information of the recipient to the recipient authorizing entity 312, and transmitted an account generation request to the recipient authorizing entity 312 to generate a virtual account associated with a virtual account identifier (the recipient account identifier) for the second token (that is associated with the recipient alias).

At step 5, the network processing server 310 may generate a second funds transfer request (e.g., a real-time funds transfer request) including the virtual recipient account identifier and the transfer amount (e.g., a PAN-based OCT message). The network processing server 310 may transmit the second funds transfer request to the recipient authorizing entity 312 in the second country. The second funds transfer request message structure may allow for cross-border screening information (e.g., sender name, recipient name, account numbers) to be transmitted. The funds transfer request may include a field indicating that the ultimate recipient of the funds is in the first country so that the recipient authorizing entity 312 may perform any validation or screening that they need to perform for cross-border transactions. The second funds transfer request may include all information (e.g., sender name, recipient name) required for the validation and screening. Upon determining that the request is approved or may move forward, the recipient authorizing entity 312 may notify the network processing server 310 that the second funds transfer request has been approved.

At step 6, the recipient authorizing entity 312 may relay the second funds transfer request received from the network processing server 310 to an instance of the global digital wallet in the second country 314. The recipient authorizing entity 312 may make the funds in the transfer amount available to the instance of the global digital wallet in the second country 314. According to various embodiments, the recipient 318 may be registered with the global digital wallet in the first country, the sender 302 may not be registered with the global digital wallet.

At step 7, the instance of the global digital wallet in the second country 314 may transfer the funds to an instance of the global digital wallet in the first country 316 via an internal ledger transfer internal to the global digital wallet. The funds are then made available to the recipient's account associated with the instance of the global digital wallet in the first country 316 at step 8.

At step 9, the network processing server 310 may perform a settlement process for at least the transfer amount between the recipient authorizing entity 312 in the second country and the sender authorizing entity 306 outside of the first country (e.g., in the second country). The transfer amount is transferred from a sender account issued by the sender authorizing entity 306 outside of the first country (e.g., in the second country) to the destination recipient account in the first country.

According to various embodiments, the sender 302 and the sender authorizing entity 306 may be located at a third country that is different from the first country where the recipient is located, and the second country where the recipient authorizing entity 312 and the instance of the global digital wallet in the second country 314 are located.

In such embodiments, the network processing server 310 may perform a cross-border settlement process for at least the transfer amount between the recipient authorizing entity 312 in the second country and the sender authorizing entity 306 in the third country. The transfer amount is transferred from a sender account issued by the sender authorizing entity 306 in the third country to the destination recipient account in the first country.

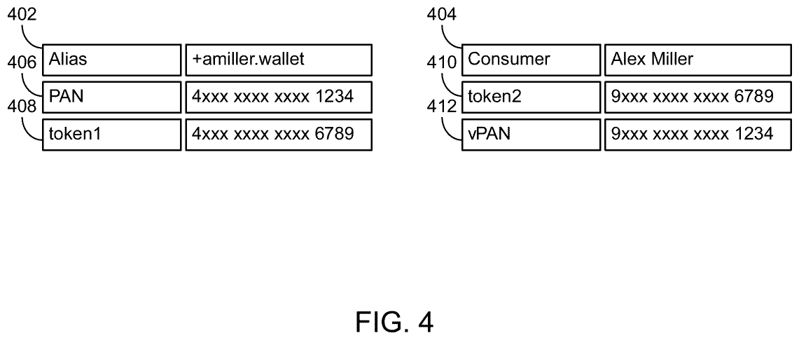

FIG. 4 shows exemplary account identifying information, according to various embodiments. The network processing server may provide an alias service that may generate aliases for registered users. For example, a user may provide a user account identifying information to the network processing server, and request an alias to be issued for them. The network processing server may generate the alias 402, and store a mapping between the alias 402 and the user account identifying information, such as a PAN 406. The network processing server may generate a first token 408 to represent the PAN 406 (e.g., the first token is a proxy for the PAN), and may associate the first token 408 with the alias 402. According to various embodiments, the user may be located in a first country, and the PAN 406 may be generated by an authorizing entity located in the first country. The network processing server may configure the first token 408 for use in the first country (e.g., the first token 408 is associated with a PAN 406 issued in the same country). The network processing server may also generate a second token 410 configured to be used in a second country. The network processing server may then request a recipient authorizing entity (e.g., a partner of the network processing server) located in the second country to issue a virtual account in the second country. The recipient authorizing entity may issue the virtual account and provide the virtual account identifier (vPAN) of the virtual account to the network processing server. The network processing server may store the vPAN as associated with the second token (e.g., the second token is a proxy for the vPAN) as well as the alias 402.

In some embodiments, the network processing server may store the mapping between the alias and the tokens (e.g., the first token and the second token) at a first database (e.g., alias vault). The network processing server may store the mapping between the accounts (PAN, vPAN) and the tokens (the first token, the second token, respectively) at a second database. Since the alias service is either a part of or otherwise managed by the network processing server, the network processing server would control both databases.

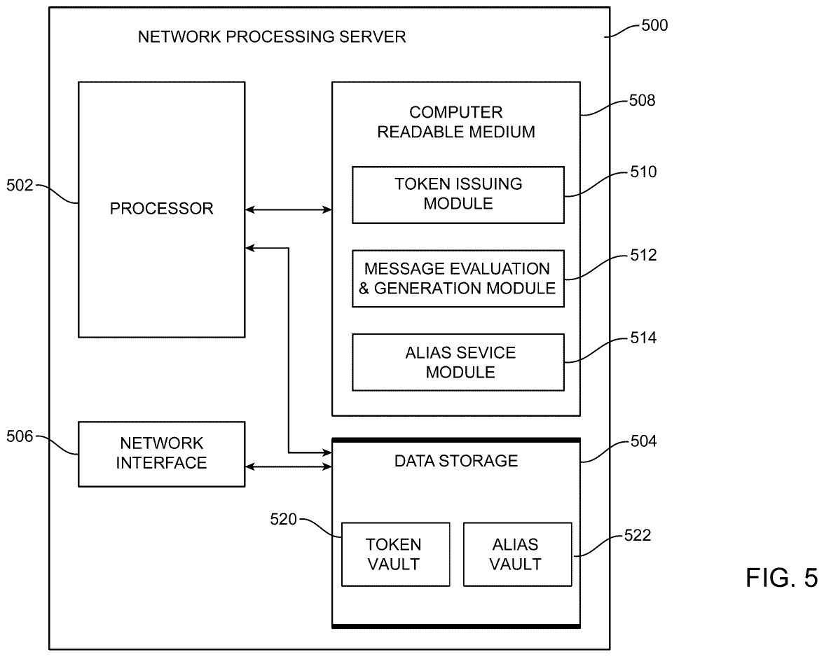

FIG. 5 illustrates a block diagram of a network processing server 500, according to various embodiments. The exemplary network processing server 500 may comprise a processor 502. The processor 502 may be coupled to a memory 504, a network interface 506, and a computer readable medium 508. The computer readable medium 508 can comprise a token issuing module 510, a message evaluation and generation module 512, and an alias service module 514. In some embodiments, the alias service module 514 may be a standalone component, provided within an alias service computer including a processor and a memory, that is managed by, or otherwise associated with, the transaction processing server 500.

The memory 504 can be used to store data and code. For example, the memory 504 can store a token vault 520, for storing tokens generated by the token issuing module 510, and an alias vault 522, for storing aliases generated by the alias service module 514. The memory 504 may be coupled to the processor 502 internally or externally (e.g., cloud based data storage), and may comprise any combination of volatile and/or non-volatile memory, such as RAM, DRAM, ROM, flash, or any other suitable memory device.

The computer readable medium 508 may comprise the token issuing module 510, the message evaluation and generation module 512, the alias service module 514, and any other suitable software module. The computer readable medium 508 may also comprise code, executable by the processor 502 for implementing a method comprising: receiving, from a sender outside of a first country, a request to resolve a recipient alias of a recipient to a token; determining that the sender is outside of the first country and the recipient alias is associated with a destination recipient account in the first country that blocks real-time transfer of inbound funds from accounts outside of the first country; retrieving a foreign token associated with the recipient alias based on identifying that the sender is outside of the first country, wherein the foreign token is associated with a virtual recipient account issued by a recipient authorizing entity in a second country; transmitting the foreign token to the sender; receiving, from a sender authorizing entity outside of the first country, a funds transfer request including the foreign token and a transfer amount; and transmitting a real-time funds transfer request to a foreign instance of a global digital wallet in the second country via the recipient authorizing entity in the second country, wherein the global digital wallet transfers the transfer amount in real-time to the destination recipient account in the first country via a ledger transfer internal to the global digital wallet.

The alias service module 514 may comprise code that causes the processor 502 to issue aliases. For example, the alias service module 514 may contain logic that causes the processor 502 to generate an alias corresponding to a user account identifier (e.g., a PAN). The alias service module 514 may work in connection with the token issuing module 510 to generate one or more tokens associated with an alias.

The token issuing module 510 may comprise code that causes the processor 502 to issue tokens. For example, the token issuing module 510 may contain logic that causes the processor 502 to generate a digital token with one or more data fields that may comprise a token identifier, an owner identifier, a counter value, an interaction identifier, a currency amount, a currency denomination, and/or a digital signature. According to various embodiments, the token issuing module 510 may issue a first token for use in a first country and a second token for use outside of the first country associated with an alias. The token issuing module 510 may store a mapping between the alias and the first token, the second token at the alias vault 522. The token issuing module may store a mapping between the first token and the user account identifier (e.g., PAN) in the token vault 520.

The message evaluation and generation module 512 may comprise code that causes the processor 502 to generate messages that will be transmitted to other entities, and/or to assess the messages transmitted to the network processing server 500 from the other entities. The message evaluation and generation module 512 may comprise code that causes the processor 502 to generate and transmit (via the network interface 506) a virtual account request message to a recipient authorizing entity in a second country. The virtual account request message may include the second token generated by the token issuing module 510 for the second account identifier (e.g., second PAN, virtual PAN) associated with the alias. As described above, the second account identifier (e.g., second PAN, virtual PAN) may be generated by the recipient authorizing entity 212. The message evaluation and generation module 512 may comprise code that causes the processor 502 to evaluate a message received from the recipient authorizing entity to identify a virtual account identifier (e.g., vPAN) in the message, and cause the processor 502 to store a mapping between the virtual account identifier and the second token at the token vault 520.

The message evaluation and generation module 512 may comprise code that causes the processor 502 to evaluate a message received from a sender authorizing entity (requesting resolving the alias to a corresponding location) to identify a location of the sender authorizing entity, and based on determining that the sender authorizing entity is located outside of the first country, causes the processor 502 to retrieve the second token from the token vault 520.

While the token vault 520 and the alias vault 522 as illustrated as separate storage constructs (e.g., databases), one of ordinary skill in the art understands that they can be formed as a single storage construct storing a mapping between an alias, corresponding tokens, and corresponding account identifiers (virtual or otherwise).

The network interface 506 may include an interface that can allow the network processing server 500 to communicate with external computers. The network interface 506 may enable the network processing server 500 to communicate data to and from another device (e.g., the sender authorizing entity, the recipient authorizing entity, etc.). Some examples of the network interface 506 may include a modem, a physical network interface (such as an Ethernet card or other Network Interface Card (NIC)), a virtual network interface, a communications port, a Personal Computer Memory Card International Association (PCMCIA) and card, or the like. The wireless protocols enabled by the network interface 506 may include Wi-Fi™. Data transferred via the network interface 506 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 506 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Embodiments provide technical improvements by enabling cross-border funds transfer into a US account using simply an alias for the recipient while ensuring regulatory compliance. Such cross-border funds transfers are currently not supported/allowed. Embodiments allow for cross-border funds transfer into a US recipient account using an OCT transfer at the foreign country to a recipient account at a global digital wallet's hub at the foreign country, and an internal ledger transfer therefrom to a recipient account at the global digital wallet's US instance using only a recipient alias. The sender uses a foreign financial application to create a funds transfer request including the recipient alias and the transfer amount. The network processing server resolves the alias to a foreign PAN issued by an authorizing entity in the foreign country, and sends an OCT request to the global digital wallet's foreign hub, via the authorizing entity in the foreign country. The global digital wallet transfers the funds between their foreign hub and the US instance via an internal ledger transfer, and makes the funds available to the recipient at their recipient account.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
linking, by a network processing server, a foreign token with a recipient alias, the foreign token being associated with a virtual recipient account issued by a recipient authorizing entity in a second country;
receiving, by the network processing server, from a sender outside of a first country, a request to resolve the recipient alias of a recipient to a token;
determining, by the network processing server, that the sender is outside of the first country and the recipient alias is associated with a destination recipient account in the first country that blocks real-time transfer of inbound funds from accounts outside of the first country;
retrieving, by the network processing server, the foreign token associated with the recipient alias based on identifying that the sender is outside of the first country;
transmitting, by the network processing server, the foreign token to the sender;
receiving, by the network processing server, from a sender authorizing entity outside of the first country, a funds transfer request including the foreign token and a transfer amount; and
transmitting, by the network processing server, a real-time funds transfer request to a foreign instance of a global digital wallet in the second country via the recipient authorizing entity in the second country, wherein the global digital wallet transfers the transfer amount in real-time to the destination recipient account in the first country via a ledger transfer internal to the global digital wallet.

2. The method of claim 1, wherein the transfer amount is transferred from the foreign instance of the global digital wallet in the second country to a domestic instance of the global digital wallet in the first country prior to being deposited into the destination recipient account in the first country.

3. The method of claim 1, wherein at least the real-time funds transfer request includes a field indicating that the destination recipient account is in the first country, and information to enable cross-border funds transfer screening.

4. The method of claim 1, further comprising:
prior to the virtual recipient account being issued by the recipient authorizing entity in the second country:
providing, by the network processing server, identity information of the recipient to the recipient authorizing entity in the second country; and
transmitting, by the network processing server, an account generation request to the recipient authorizing entity in the second country to generate the virtual recipient account associated with the recipient alias.

5. The method of claim 1, wherein the recipient alias is also associated with a domestic token for transactions within the first country, and wherein the network processing server assesses a location of the sender before correctly retrieving the foreign token associated with the recipient alias.

6. The method of claim 1, wherein each one of the funds transfer request received by the network processing server from the sender authorizing entity outside of the first country and the real-time funds transfer request transmitted by the network processing server to foreign instance of the global digital wallet in the second country is an Original Credit Transaction (OCT) message used as part of cross-border fund transfer into the first country.

7. The method of claim 1, further comprising:
performing, by the network processing server, a settlement process for at least the transfer amount between the recipient authorizing entity in the second country and the sender authorizing entity outside of the first country, wherein the transfer amount is transferred from a sender account issued by the sender authorizing entity outside of the first country to the destination recipient account in the first country.

8. The method of claim 1, further comprising:
identifying, by the network processing server, a virtual recipient account identifier associated with the virtual recipient account in the second country; and
generating, by the network processing server, the real-time funds transfer request including the virtual recipient account identifier; and
generating, by the network processing server, the real-time funds transfer request including the virtual recipient account and the transfer amount and the transfer amount.

9. The method of claim 1, wherein the recipient is registered with the global digital wallet in the first country, the sender is not registered with the global digital wallet.

10. The method of claim 1, wherein the sender and the sender authorizing entity are located in the second country.

11. The method of claim 1, wherein the sender and the sender authorizing entity are located in a third country, and the method further comprises:
performing, by the network processing server, a cross-border settlement process for at least the transfer amount between the recipient authorizing entity in the second country and the sender authorizing entity in the third country, wherein the transfer amount is transferred from a sender account issued by the sender authorizing entity in the third country to the destination recipient account in the first country.

12. A network processing server comprising:
a processor; and
a computer-readable medium comprising code, executable by the processor to perform operations comprising:
linking a foreign token with a recipient alias, the foreign token being associated with a virtual recipient account issued by a recipient authorizing entity in a second country;
receiving, from a sender outside of a first country, a request to resolve the recipient alias of a recipient to a token;
determining that the sender is outside of the first country and the recipient alias is associated with a destination recipient account in the first country that blocks real-time transfer of inbound funds from accounts outside of the first country;
retrieving the foreign token associated with the recipient alias based on identifying that the sender is outside of the first country;
transmitting the foreign token to the sender;
receiving, from a sender authorizing entity outside of the first country, a funds transfer request including the foreign token and a transfer amount; and
transmitting a real-time funds transfer request to a foreign instance of a global digital wallet in the second country via the recipient authorizing entity in the second country, wherein the global digital wallet transfers the transfer amount in real-time to the destination recipient account in the first country via a ledger transfer internal to the global digital wallet.

13. The network processing server of claim 12, wherein the transfer amount is transferred from the foreign instance of the global digital wallet in the second country to a domestic instance of the global digital wallet in the first country prior to being deposited into the destination recipient account in the first country.

14. The network processing server of claim 12, wherein at least the real-time funds transfer request includes a field indicating that the destination recipient account is in the first country, and information to enable cross-border funds transfer screening.

15. The network processing server of claim 12, wherein the operations further comprise:
prior to the virtual recipient account being issued by the recipient authorizing entity in the second country:
providing, by the network processing server, identity information of the recipient to the recipient authorizing entity in the second country; and
transmitting, by the network processing server, an account generation request to the recipient authorizing entity in the second country to generate the virtual recipient account associated with the recipient alias.

16. The network processing server of claim 12, wherein the recipient alias is also associated with a domestic token for transactions within the first country, and wherein the network processing server assesses a location of the sender before correctly retrieving the foreign token associated with the recipient alias.

17. The network processing server of claim 12, wherein each one of the funds transfer request received by the network processing server from the sender authorizing entity outside of the first country and the real-time funds transfer request transmitted by the network processing server to foreign instance of the global digital wallet in the second country is an Original Credit Transaction (OCT) message used as part of cross-border fund transfer into the first country.

18. The network processing server of claim 12, wherein the sender and the sender authorizing entity are located in the second country, and wherein the operations further comprise:
performing a settlement process for at least the transfer amount between the recipient authorizing entity in the second country and the sender authorizing entity in the second country, wherein the transfer amount is transferred from a sender account issued by the sender authorizing entity in the second country to the destination recipient account in the first country.

19. The network processing server of claim 12, wherein the recipient is registered with the global digital wallet in the first country, the sender is not registered with the global digital wallet.

20. The network processing server of claim 12, wherein the sender and the sender authorizing entity are located in a third country, and the operations further comprise:
performing a cross-border settlement process for at least the transfer amount between the recipient authorizing entity in the second country and the sender authorizing entity in the third country, wherein the transfer amount is transferred from a sender account issued by the sender authorizing entity in the third country to the destination recipient account in the first country.
